(19) United States
(12) Patent Application Publication
(10) Pub. No.: US 2007/0077836 A1
(43) Pub. Date: Apr. 5, 2007

(54) Methods and apparatus for stabilizing exposed fabric edge

(75) Inventors: Vishal Bansal, Overland Park, KS (US); James P. Lenox, Kansas City, MO (US); Lou Fuhrmann, Kansas City, MO (US); James Roy Doehla, Pleasant Hill, MO (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/241,459

(22) Filed: Sep. 30, 2005

(51) Int. Cl. B32B 27/12; B32B 27/04

(52) U.S. Cl. 442/148; 442/149; 442/152; 442/164; 442/172; 427/407.1

(57) ABSTRACT

Methods and apparatus for stabilizing an exposed fabric edge are described. In one example embodiment, a base material includes at least one edge. A light cured adhesive is applied over the base material edge.

### BACKGROUND OF THE INVENTION

This invention relates generally to fabric garments and panels and more particularly, to stabilizing exposed fabric edges.

Over a period of time and use, exposed edges of a garment or panel may delaminate, unravel, split, or otherwise become unstable. As an example, a garment edge that may be particularly vulnerable to instability is adjacent a zipper. As the zipper is opened and closed, there may be abrasion forces that cause the edge to fray or otherwise become unstable.

In at least some applications, the stability of the fabric at the fabric edges is related to overall performance of the garment of panel. For example, in some environmental applications, if a fabric edge becomes unstable, a leakage path may be established. Of course, such leakage may be undesirable. In order to maintain the waterproof characteristics of a garment or panel, for example, any delamination, unraveling, or splitting at the material edges may result in the material losing its waterproof characteristics.

In an attempt to provide increased material stability at edges, it is known to fold over and stitch the material at the edge. The process can be cumbersome and visually unattractive. Another known approach is to utilize ultraviolet (UV) radiation curable silicon on the fabric edge. Garment fabrication, however, typically is manual labor intensive. Use of UV curable silicon on a garment may expose workers to unacceptable levels of radiation.

### BRIEF DESCRIPTION OF THE INVENTION

In one aspect, an article is provided that includes a base material. The base material has at least one edge. A light cured adhesive is applied over an edge of the base material.

In another aspect, a method of making an article is provided. The method includes providing a base material, applying a light curable adhesive over an edge of the base material, and curing the adhesive with a visible light source.

In yet another aspect, an article including a base material is provided. The base material is selected from a group of materials including polypropylene, polyester, acrylic, polyphenelene sulfide, aramid, polymide, glass, expanded polytetrafluoroethylene, woven polytetrafluoroethylene, and non woven polytetrafluoroethylene. The base material has at least one edge. A visible light cured adhesive extends over the base material edge. The adhesive is one of acrylate based and urethane based.

### BRIEF DESCRIPTION OF THE DRAWINGS

FIG. 1 is a front view of a garment; and

FIG. 2 is a front view of another garment.

### DETAILED DESCRIPTION OF THE INVENTION

The present invention is sometimes described herein in the context of a composite article. The present invention, however, is not limited to practice with any one specific type of article and generally can be used in connection with any fabric. The article can, for example, be a garment or a panel.

In an example embodiment, the composite article includes a base material, a porous membrane having a plurality of pores, and a coating applied to the porous membrane that provides oleophobic properties to the composite article. There are numerous uses for a porous membrane that has oleophobic properties. Such a membrane can be used, for example, as filter media, garments, and/or apparel. Although the article may be used to filter anything, in some embodiments the composite article is used as filter media for air pollution control.

The base material may be any type of material, such as, but not limited to, felt or a woven fabric. Although the base material may include other materials, in some embodiments, the base material includes polyester, Nomex®, nylon, and/or acrylic. Specifically, the base material may be selected from a group of materials including polypropylene, polyester, acrylic, polyphenelene sulfide, aramid, polymide, glass, expanded polytetrafluoroethylene, woven polytetrafluoroethylene, and non woven polytetrafluoroethylene. For example, in one specific embodiment, the base material is BHA-TEX® Polyester QP131 or QP136 commercially available from BHA Group, Inc. of Kansas City, Mo. Although base material may be formed in other ways, in some embodiments, the base material is woven, heated, compressed, and/or treated with chemicals.

The composite article also includes a membrane laminated with the base material. The membrane is porous, and in some embodiments microporous, with a three-dimensional matrix or lattice type structure of a plurality of nodes interconnected by a plurality of fibrils. The membrane is made from any suitable material, such as, for example, expanded polytetrafluoroethylene (ePTFE), as is known in the art.

A coating layer may be formed on at least a portion of the porous membrane. The coating layer may have oleophobic properties and be a copolymer formed from at least one of a perfluoro alkyl acrylic copolymer and a perfluoro alkyl methacrylic copolymer.

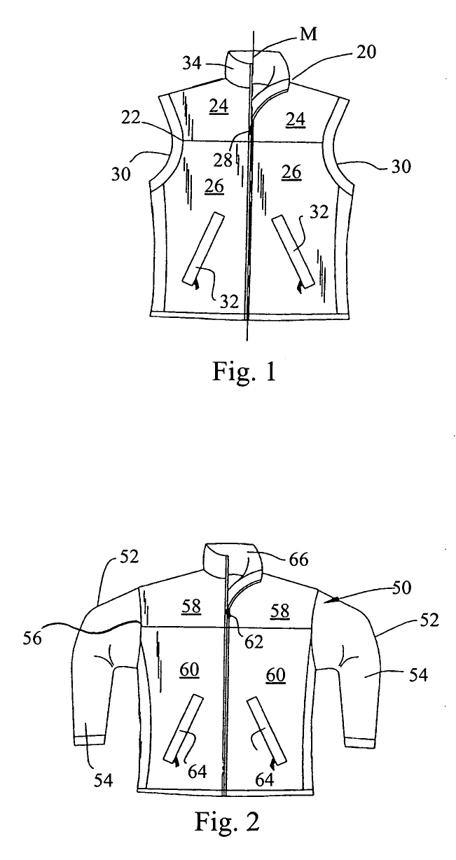

FIG. 1 illustrates a front view of a vest 20 and FIG. 2 illustrates a jacket 50. The illustrated embodiments are not intended to limit the scope of the present invention because other uses are also contemplated. Vest 20 is constructed to inhibit relatively moving air from contacting at least a portion of a person wearing the vest while being moisture vapor transmissive and water-resistant. Vest 20 includes a wind proof front panel 22 adapted to cover at least a portion of the front upper torso of a person wearing vest 20. Vest 20 is divided into a pair of equal sized sides by a mid-plane M of the vest. Each side of front panel 22 of vest 20 includes an upper front panel portion 24 and a lower front panel portion 26. Upper front panel portion 24 on each side of the vest 20 is attached to lower front panel portion 26 in an appropriate manner, such as by sewing.

Front panel 22 of vest 20 includes a full-length zipper 28. Vest 20 may optionally include a wind flap (not shown) adjacent zipper 28. Vest 20 has a pair of armholes 30. Each armhole 30 may receive an arm of the wearer. Vest 20 also includes a pair of pockets 32. Each pocket 32 is located on a respective side of front panel 22 of vest 20 and includes a wind flap. Vest 20 includes a collar 34 to extend around the neck of the person wearing vest 20. Further details regarding vest 20 are set forth in U.S. Pat. No. 6,018,819, which is assigned to the present assignee.

FIG. 2 illustrates a jacket 50 constructed to inhibit relatively moving air from contacting a portion of a person wearing the jacket while being moisture vapor transmissive and water-resistant. Jacket 50 is constructed similar to the vest 20 with the addition of sleeves 52. Each sleeve 52 of jacket 50 includes a front sleeve panel 54. Front sleeve panel 54 on each sleeve 52 is attached to a rear sleeve panel (not shown) in an appropriate manner, such as by sewing. Front sleeve panel 54 is adapted to cover a portion of the front of a person's arm wearing the jacket. Jacket 50 is divided into a pair of sides by a mid-plane (not shown) of the jacket. Each front sleeve panel 54 is constructed in a similar manner to the front panel portions 24 and 26 of vest 20.

Front panel 56 of jacket 50 is adapted to cover at least a portion of the front of a person wearing the jacket. Front panel 56 includes an upper front panel portion 58 and a lower front panel portion 60. Jacket 50 includes a zipper 62. Jacket 50 may optionally include a wind flap (not shown) which may be on the interior or exterior of the jacket. Jacket 50 also includes a pair of pockets 64. Each pocket 64 is located on a side of jacket 50 in front and has a wind flap. Jacket 50 includes a collar 66. Further details regarding jacket 50 are set forth in U.S. Pat. No. 6,018,819, which is assigned to the present assignee.

To seal the exposed fabric edges of vest 20 and jacket 50, e.g., at the location of zippers 28 and 62, respectively, visible light curable adhesives are utilized. Such adhesives may, for example, be acrylate or urethane based, and is well known in the art. More specifically, the adhesive is applied to the fabric edge. The adhesive is then cured using a light source, such as a high intensity visible light source. Such light sources are well known in the art. A typical wavelength for such a light source is 405 nm. The adhesive forms a transparent, thin, and flexible seal, that withstands multiple wash cycles while maintaining the protective function to the fabric edge. Such adhesive and visible lights sources are known and commercially available from, for example, Henkel Loctite Corporation, 1001 Trout Brook Crossing, Rocky Hill, Conn. 06067-3910.

Such adhesives can be used with construction of any garment in which sealing of the edge is a requirement, such as PU garments, ePTFE+PU garments, and ePTFE garments.

Using a visible light curable adhesive avoids the radiation exposures problems associated with UV light sources. In addition, applying and curing visible light curable adhesives is easy and typically does not alter the aesthetic qualities of a garment or panel.

In one exemplary embodiment, a three layer fabric laminate, such as eVI38-3L, used make waterproof breathable garments was obtained from BHA Technologies, Inc., 8800 East 63^{rd} Street, Kansas City, Mo. 64113. The three layers in this laminate are a woven polyamide face fabric, an olephobically treated microporous ePTFE membrane, and a Nylon knit backing fabric. A sample of material was cut from the fabric laminate using a mechanical sample clicker. The sample had four exposed un-stabilized edges, which had tendency to fray even on application of low abrasion. A thin uniform coating of light curable adhesive, such as Loctite® 3105, commercially available from Henkel Corporation, Rocky Hill, Conn., was applied to the material. The adhesive was cured using a hand-held high intensity visible light source, such as the Loctite® 7700 handheld LED light source, commercially available from Henkel Corporation, Rocky Hill, Conn. The light source was kept approximately 1 cm from the fabric and traversed at speed of approximately 5 cms/sec. The resultant sample was found to have stabilized edges which do not unravel or fray.

Exemplary embodiments of articles and methods are described and/or illustrated herein in detail. The articles and methods are not limited to the specific embodiments described herein, but rather, components of each article and steps of each method may be utilized independently and separately from other articles and steps described herein. Each article component and method step can also be used in combination with other article components and/or method steps.

While the invention has been described in terms of various specific embodiments, those skilled in the art will recognize that the invention can be practiced with modification within the spirit and scope of the claims.

What is claimed is:

1. An article comprising a base material, said base material having at least one edge, a light cured adhesive applied over an edge of said base material.

2. An article in accordance with claim 1 further comprising a porous membrane laminated with said base material, said porous membrane having hydrophobic properties and comprising at least one of expanded polytetrafluoroethylene, woven polytetrafluoroethylene, and non woven polytetrafluoroethylene.

3. An article in accordance with claim 2 further comprising a coating layer formed on at least a portion of said porous membrane, said coating layer having oleophobic properties and comprising a copolymer formed from at least one of a perfluoro alkyl acrylic copolymer and a perfluoro alkyl methacrylic copolymer.

4. An article in accordance with claim 1 further comprising a porous membrane laminated with said base material, said porous membrane having hydrophobic properties and comprising a microporous polyeolefinic membrane.

5. An article in accordance with claim 1 wherein said base material comprises a material selected from a group of materials comprising polypropylene, polyester, acrylic, polyphenelene sulfide, aramid, polymide, glass, expanded polytetrafluoroethylene, woven polytetrafluoroethylene, and non woven polytetrafluoroethylene.

6. An article in accordance with claim 1 further comprising a zipper secured to said base material, said base material edge located adjacent said zipper.

7. A method of making an article, said method comprising:
providing a base material;
applying a light curable adhesive over an edge of the base material; and
curing the adhesive with a visible light source.

8. A method according to claim 7 wherein the base material comprises a material selected from a group of materials comprising polypropylene, polyester, acrylic, polyphenelene sulfide, aramid, polymide, glass, expanded polytetrafluoroethylene, woven polytetrafluoroethylene, and non woven polytetrafluoroethylene.

9. A method according to claim 7 further comprising laminating the base material with a porous membrane, the porous membrane having hydrophobic properties.

10. A method according to claim 9 wherein the porous membrane has hydrophobic properties and comprising expanded polytetrafluoroethylene.

11. A method according to claim 9 wherein the porous membrane has hydrophobic properties and comprising of microporous polyolefinic membrane.

12. A method according to claim 9 further applying a coating of a coating material to the porous membrane.

13. A method according to claim 12 wherein the coating layer has oleophobic properties and comprises a copolymer formed from at least one of a perfluoro alkyl acrylic copolymer and a perfluoro alkyl methacrylic copolymer.

14. An article comprising a base material, said base material comprising a material selected from a group of materials comprising polypropylene, polyester, acrylic, polyphenelene sulfide, aramid, polymide, glass, expanded polytetrafluoroethylene, woven polytetrafluoroethylene, and non woven polytetrafluoroethylene, said base material having at least one edge, a visible light cured adhesive applied to said base material edge, said adhesive being one of be acrylate based and urethane based.

15. An article in accordance with claim 14 further comprising a porous membrane laminated with said base material, said porous membrane having hydrophobic properties and comprising expanded polytetrafluoroethylene.

16. An article in accordance with claim 14 further comprising a porous membrane laminated with said base material, said porous membrane having hydrophobic properties and comprising of microporous polyolefinic membrane.

17. An article in accordance with claim 14 further comprising a coating layer formed on at least a portion of said porous membrane, said coating layer having oleophobic properties and comprising a copolymer formed from at least one of a perfluoro alkyl acrylic copolymer and a perfluoro alkyl methacrylic copolymer.

18. An article in accordance with claim 14 further comprising a zipper secured to said base material, said base material edge located adjacent said zipper.
